(19) United States
(12) Patent Application Publication
(10) Pub. No.: US 2014/0282645 A1
(43) Pub. Date: Sep. 18, 2014

(54) METHODS AND APPARATUS TO USE SCENT TO IDENTIFY AUDIENCE MEMBERS

(71) Applicant: Eric R. Hammond, Palm Harbor, FL (US)

(72) Inventor: Eric R. Hammond, Palm Harbor, FL (US)

(21) Appl. No.: 13/797,212

(22) Filed: Mar. 12, 2013

(51) Int. Cl. H04N 21/442

(52) U.S. Cl. CPC H04N 21/44218
USPC 725/12

(57) ABSTRACT

Methods and apparatus to use scent to collect audience information are disclosed. An example apparatus includes a media meter to collect media identification information to identify media presented by an information presentation device; a people meter to identify a person in an audience of the information presentation device. The people meter includes a scent detector to detect a first scent of the person; a scent database containing a set of reference scents; a scent comparer to determine a first likelihood that the person corresponds to a first panelist identifier by comparing the first scent to at least some of the reference scents in the set; and identification logic to identify the person as corresponding to the first panelist identifier based on the first likelihood.

### FIELD OF THE DISCLOSURE

This disclosure relates generally to audience measurement and, more particularly, to methods and apparatus to use scent to identify audience members.

### BACKGROUND

Consuming media presentations generally involves listening to audio information and/or viewing video information such as, for example, radio programs, music, television programs, movies, still images, etc. Media-centric companies such as, for example, advertising companies, broadcasting networks, etc. are often interested in the viewing and listening interests of their audience to better market their products

### BRIEF DESCRIPTION OF THE DRAWINGS

FIG. 1 is a block diagram of an example audience measurement system constructed in accordance with the teachings of this disclosure shown in an example environment of use.

FIG. 2 is a block diagram of an example implementation of the example electronic nose 110 of FIG. 1.

FIG. 3 is a flowchart representative of example machine readable instructions that may be executed to implement the example people meter 108 of FIG. 1.

FIG. 4 is a block diagram of an example implementation of a people meter 400.

FIG. 5 is a block diagram of an example implementation of the example image processor 401 of FIG. 4.

FIG. 6 is a block diagram of an example implementation of the example audio processor 402 of FIG. 4.

FIG. 7 is a block diagram of an example implementation of the example media meter 106 of FIG. 1.

FIGS. 8, 9A, 9B and 11 are flowcharts representative of example machine readable instructions that may be executed to implement the example people meter 400 of FIG. 4.

FIG. 10 is a flowchart representative of example machine readable instructions that may be executed to implement the example media meter 106 of FIGS. 1 and/or 7.

FIG. 12 is an example scent record that may be generated by the example electronic nose of FIG. 2.

FIG. 13 is an example image record that may be generated by the example image processor 400 of FIG. 6.

FIG. 14 is an example audio record that may be generated by the example audio processor 402 of FIG. 7.

FIG. 15 is an example table that may be generated by the example people meter 400 of FIG. 4.

FIG. 16 is a block diagram of an example processing system capable of executing the example machine readable instructions of FIGS. 3, 8-10 and/or 11 to implement the example people meter 108 of FIG. 1, the example people meter 400 of FIG. 4 and/or to implement the example media meter 106 of FIGS. 1 and/or 7.

### DETAILED DESCRIPTION

It is often desirable to measure the number and/or demographics of audience members exposed to media. To this end, the media exposure activities of audience members are often monitored using one or more meters, placed near a media presentation device such as a television. A meter may be configured to use any of a variety of techniques to monitor the media exposure (e.g., viewing and/or listening activities) of a person or persons. Generally, these techniques involve (1) a mechanism for identifying media and (2) a mechanism for identifying people exposed to the media. For example, one technique for identifying media involves detecting and/or collecting media identifying and/or monitoring information (e.g., tuning data, metadata, codes, signatures, etc.) from signals that are emitted or presented by media delivery devices (e.g., televisions, stereos, speakers, computers, etc.). A meter to collect this sort of data may be referred to as a media identifying meter.

Some example media identifying meters monitor media exposure by collecting media identifying data from the audio output by the media presentation device. As audience members are exposed to the media presented by the media presentation device, such media identifying meters detect the audio associated with the media and generate media monitoring data. In general, media monitoring data may include any information that is representative of (or associated with) and/or that may be used to identify particular media (e.g., content, an advertisement, a song, a television program, a movie, a video game, radio programming, etc.) For example, the media monitoring data may include signatures that are collected or generated by the media identifying meter based on the media, audio that is broadcast simultaneously with (e.g., embedded in) the media, tuning data, etc.

To assign demographics and/or size to the audience of media, it is advantageous to identify the composition of the audience (e.g., the number of audience members, the demographics of the audience members, etc.). Many methods of identifying the members of the audience of media employ a people meter. Some people meters are active in that they require the audience members (e.g., panelists) to identify themselves (e.g., by selecting the members of the audience from a list on the meter, pushing buttons corresponding to the names of the audience members, etc.). However, audience members do not always remember to enter such information and/or audience members can tire of prompting to enter such data and refuse to comply and/or dropout of the study. Passive people meters attempt to address this problem by seeking to automatically identify audience members thereby obviating the need for audience members to self-identify. As used herein, panelists refer to people who have agreed to have their media exposure monitored. Panelists may register to participate in the data collection process and typically provide their demographic information (e.g., age, gender, etc.) as part of the registration process.

Examples methods and apparatus disclosed herein automatically identify audience members without requiring affirmative action to be taken by the audience members. In examples disclosed herein, a people meter automatically detects audience members in a media exposure area (e.g., a family room, a TV room in a household, a bar, a restaurant, etc.). In examples disclosed herein, the people meter automatically detects the scent(s) of audience member(s) and attempts to identify and/or identifies the audience member(s) based on the detected scent(s). In some examples, the people meter uses data in addition to the scents to identify audience members. For instance, in some examples disclosed herein, the people meter captures an image of the audience and attempts to identify and/or identifies the audience member(s) based on the captured image. In examples disclosed herein, the people meter additionally or alternatively captures audio from the audience member(s) and attempts to identify and/or identifies the audience member(s) based on the captured audio. In some examples disclosed herein, the people meter combines the information determined from the detected scent(s), the captured image, and the captured audio to attempt to identify the audience member(s).

FIG. 1 is a block diagram of an example measurement system 100 constructed in accordance with the teachings of this disclosure and shown monitoring an example media presentation environment 102. The example media environment of FIG. 1 includes an area 102, a media device 104, and a panelist 112. The example system 100 of FIG. 1 includes a media identifying meter 106, a people meter 108 having an electronic nose 110, and a central facility 116.

Although the area 102 of the illustrated example is located in a household, in some examples, the area 102 is another type of area such as an office, a store, a restaurant, a bar, etc.

The media device 104 of the illustrated example is a device (e.g., a television, a radio, etc.) that delivers media (e.g., content and/or advertisements). The panelist 112 in the household 102 is exposed to the media delivered by the media device 104.

The media identifying meter 106 of the illustrated example monitors media signal(s) presented by the media device 104 (e.g., an audio portion of a media signal). The example media meter 106 of FIG. 1 processes the media signal (or a portion thereof) to extract media identification information such as codes and/or metadata, and/or to generate signatures for use in identifying the media and/or a station transmitting the media. In some examples, the media meter 106 timestamps the media identification information.

The example media meter 106 also communicates with the example people meter 108 to receive people identification information about the audience exposed to the media presentation (e.g., the number of audience members, demographic information about the audience, etc.). The media meter 106 of the illustrated example collects and/or processes the audience measurement data (e.g., the media identification data and/or the people identification information) locally and/or transfers the (processed and/or unprocessed) data to the remotely located central data facility 116 via a network 114 for aggregation with data collected at other panelist locations for further analysis.

The people meter 108 of the illustrated example detects the people (e.g., audience members) in the household 102 exposed to the media signal presented by the media device 104. In the illustrated example, the people meter 108 attempts to automatically determine the identities of the audience members. Such automatic detection of identity of a person may be referred to as passive identification. In some examples, the people meter 108 counts the number of audience members. In some examples, the people meter 108 determines the specific identities of the audience members without prompting the audience member(s) to self-identify. Detecting specific identifies enables mapping demographic information of the audience members to the media identified by the media meter 106. Such mapping can be achieved by using timestamps applied to the media identification data collected by the media meter 106 and timestamps applied to the people identification data collected by the people meter 108. The example people meter 108 of FIG. 1 contains an electronic nose 110 to collect scent(s) of the audience and attempt to identify specific individual(s) in the audience based on the scent(s). An example implementation of the electronic nose 110 is discussed below in connection with FIG. 2.

The panelist 112 of the illustrated example is exposed to the media signal presented by the media device 104. The example panelist 112 is a person who has agreed to participate in a study to measure exposure to media. The example panelist 112 of the illustrated example has been assigned a panelist identifier and has provided his/her demographic information.

The central facility 116 of the illustrated example collects and/or stores monitoring data, such as, for example, media exposure data, media identifying data, and/or people identifying data that is collected by the example media meter 106 and/or the example people meter 108. The central facility 114 may be, for example, a facility associated with The Nielsen Company (US), LLC, any affiliate of The Nielsen Company (US), LLC or another entity. In a typical implementation, many panelists at many locations are monitored. Thus, there are many monitored areas such as area 102 monitored by many media meters such as meter 106 and many people meters such as people meter 108. The monitoring data for all these locations are aggregated and processed at the central facility 116. In the interest of simplicity of discussion, the following description will focus on one such area 102 monitored by one media meter 106 and one people meter 108. However, it will be understood that many such monitored areas (in the same or different households) and many such meters 106,108 may exist.

In the illustrated example, the media meter 106 is able to communicate with the central facility 116 and vice versa via the network 114. The example network 114 of FIG. 1 allows a connection to be selectively made and/or torn down between the example media meter 106 and the example data collection facility 116. The example network 114 may be implemented using any type of public or private network such as, for example, the Internet, a telephone network, a local area network (LAN), a cable network, and/or a wireless network. To enable communication via the example network 114, each of the example media meter 106 and the example central facility 116 of FIG. 1 of the illustrated example includes a communication interface that enables connection to an Ethernet, a digital subscriber line (DSL), a telephone line, a coaxial cable and/or a wireless connection, etc.

FIG. 2 is a block diagram of an example implementation of the example electronic nose 110 of FIG. 1. An electronic nose is a sensor that detects scents. The example electronic nose 110 of the illustrated example includes a scent detector 200, a scent comparer 202 and a scent reference database 204.

The scent detector 200 of the illustrated example detects scents of one or more panelists 112 present in the monitored area 102. The scent detector 200 may detect a scent using chemical analysis or any other techniques. The example scent detector 200 generates a “scent fingerprint” of the scent; that is a mathematical representation of one or more specific characteristics of the scent that may be used to (preferably uniquely) identify the scent. The example scent detector 200 of the illustrated example communicates with an example local database 412 to store detected scent fingerprints. The local database 412 is discussed further in connection with FIG. 5.

The scent comparer 202 of the illustrated example compares a scent fingerprint detected by the scent detector 200 to one or more known reference scent fingerprints. That is, the scent comparer 202 compares the scent fingerprint of the detected scent to the scent fingerprint(s) of reference scent(s). Scent fingerprints of reference scents may be referred to as “reference scent fingerprints.” In the illustrated example, the scent comparer 202 determines the likelihood that the detected scent matches a reference scent based on how closely the scent fingerprint of the detected scent matches the fingerprint of the reference scent fingerprint of the reference scent. In the illustrated example, the scent comparer 202 compares detected scent fingerprints to reference scent fingerprints stored in the scent reference database 204. Alternatively, the example scent comparer 202 may compare detected scent fingerprints to reference scent fingerprints stored in the local database 412.

The scent reference database 204 of the illustrated example contains reference scent fingerprints. The example scent reference database 204 contains reference scent fingerprints that correspond to the panelist 112 and/or other persons who may be present in the household 102. In the illustrated example, reference scents from the panelist 112 and/or other individuals to be monitored by the audience measurement system 100 are detected by the scent detector 200 or another scent detection device during a training or setup procedure and/or are learned over time in connection with identifications received after prompts and stored as reference scent fingerprints in the scent reference database 204 and/or the local database 412. The reference scent fingerprints are stored in association with respective panelist identifiers that are assigned to respective ones of the panelists. These panelist identifiers are also stored in association with the demographics of the corresponding individuals to enable mapping of demographics to media.

While an example manner of monitoring an environment with a media meter 106, a people meter 108 having an electronic nose 110, and an example manner of implementing the electronic nose 110 has been illustrated in FIGS. 1 and/or 2, one or more of the elements, processes and/or devices illustrated in FIG. 2 may be combined, divided, re-arranged, omitted, eliminated and/or implemented in any other way. Further, the example media meter 106, the example people meter 108, the example scent detector 200, the example scent comparer 202, the example scent reference database 204, and/or the example electronic nose 110 of FIGS. 1 and/or 2 may be implemented by hardware, software, firmware and/or any combination of hardware, software and/or firmware. Thus, for example, any of the example scent detector 200, the example scent comparer 202, the example scent reference database 204, and/or, more generally, the example electronic nose 110 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example media meter 106, the example people meter 108, the example scent detector 200, the example scent comparer 202, the example scent reference database 204, and/or the example electronic nose 110 of FIGS. 1 and/or 2 are hereby expressly defined to include a tangible computer readable storage device or storage disc such as a memory, DVD, CD, Blu-ray, etc. storing the software and/or firmware. Further still, the example media meter 106, the example people meter 108, the example scent detector 200, the example scent comparer 202, the example scent reference database 204, and/or the example electronic nose 110 of FIGS. 1 and/or 2 may include one or more elements, processes and/or devices in addition to, or instead of, those illustrated in FIG. 2, and/or may include more than one of any or all of the illustrated elements, processes and devices.

Flowcharts representative of example machine readable instructions for implementing the example people meter 108 of FIGS. 1 and 2 are shown in FIG. 3. In this example, the machine readable instructions comprise a program for execution by a processor such as the processor 1612 shown in the example processor platform 1600 discussed below in connection with FIG. 16. The programs may be embodied in software stored on a tangible computer readable storage medium such as a CD-ROM, a floppy disk, a hard drive, a digital versatile disk (DVD), a Blu-ray disk, or a memory associated with the processor 1612, but the entire program and/or parts thereof could alternatively be executed by a device other than the processor 1612 and/or embodied in firmware or dedicated hardware. Further, although the example program is described with reference to the flowcharts illustrated in FIG. 3, many other methods of implementing the example people meter 108 of FIGS. 1 and 2 may alternatively be used. For example, the order of execution of the blocks may be changed, and/or some of the blocks described may be changed, eliminated, or combined.

As mentioned above, the example processes of FIG. 3 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIG. 3 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 3 is a flowchart representative of example machine readable instructions for implementing the example people meter 108 of FIG. 1. The example of FIG. 3 begins when the example scent detector 200 detects one or more scent(s) (block 302). The example scent comparer 202 compares the scent fingerprint(s) of the detected scent(s) to one or more reference scent fingerprints in the example scent reference database 204 and/or the example local database 412 (block 304). For each detected scent fingerprint, the example scent comparer 202 determines whether the detected scent matches a scent in the example scent reference database or the example local database 412 (block 306) based on a similarity of the scent fingerprint and the reference scent fingerprint.

This comparison can be done in any desired manner. In the illustrated example, the scent comparer 202 determines absolute values of differences between the scent fingerprint under evaluation and the reference scent fingerprints. The closer the value of their difference is to zero, the more likely that a match has occurred. The result of the comparison performed by the example scent comparer 202 is then converted to a likelihood of a match using any desired conversion function. The operation of the scent comparer 202 may be represented by the following equation:

L_{S}_{_{N}}_{=|SF-RSF}_{_{N}}_{|*F}

Where L_{SN} is the likelihood of a match between (a) the scent fingerprint (SF) under consideration and (b) reference scent fingerprint N (RSF_{N}), and F is a mathematical function for converting the fingerprint difference to a probability. The above calculation is performed N times (i.e., once for every reference scent fingerprint in the scent reference database 204. In some examples, after the likelihoods are determined, the scent comparer 202 selects the highest likelihood(s) (LS_{N}) as the closest match. The person(s) corresponding to the highest likelihood(s) are, thus, identified as present in the audience.

In some examples, the number of persons in the room (x) are determined (e.g., through an image processor and people counting method such as that described in U.S. Pat. No. 7,609,853 and/or U.S. Pat. No. 7,203,338, which are hereby incorporated by reference in their entirety). In such examples, the panelists corresponding to the top x likelihoods (LS_{N}) are identified in the room, where x equals the number of people in the audience. In some such examples, the scent comparer 202 compares the top x likelihoods (or the lowest of the top x likelihoods) to a threshold (e.g., 50%, 75%, etc.) to determine if the matches are sufficiently close to be relied upon. If one or more of the likelihoods are too low to be relied upon, the scent comparer 202 of such examples determines it is necessary to prompt the audience to self-identify (e.g., control advances from block 306 to 314 in FIG. 3).

In some examples, scent likelihoods (LS_{N}) are but one of several likelihoods considered in identifying the audience member(s). In such examples, all of the likelihoods (LS_{N}) are stored in association with the panelist identifier of the corresponding panelist and in association with the record ID of the captured scent (e.g., a time at which the scent was captured) to enable usage of the likelihood in one or more further calculations. An example of such an approach is discussed in detail below.

Returning to the discussion of FIG. 3, if the example scent comparer 202 determines that one or more of the detected scent(s) do not match a reference scent (or one or more match likelihood(s) are too low to reasonably rely upon) (block 306), then control passes to block 314. If the example scent comparer determines that all of the detected scent fingerprints match at least one a reference scent fingerprint (block 306), the example people meter 108 determines whether the panelist(s) corresponding to the detected scent fingerprint(s) is the same panelist as a panelist recently identified by the example people meter 108 (e.g., within the last thirty seconds, the last minute, the last few minutes, etc.) (block 308). If the example people meter 108 determines that the detected scent(s) match previously identified panelist(s) (block 308), there is no need to confirm the identity of the panelist(s) again and control passes to block 318. If the example people meter 108 determines that the detected scent(s) do not match the recently identified panelist(s) (i.e., there is a change in the composition of people in the room) (block 308), then the example people meter 108 prompts the audience to confirm that the identities determined by the example people meter 108 correctly match the identities of the people in the room (block 310).

If the audience member(s) (e.g., panelist 112) confirm that the example people meter 108 correctly identified the people in the room (block 312), then control passes to block 318. If the audience member(s) (e.g., panelist 112) do not confirm that the example people meter 108 correctly identified the people in the room (block 312), then the example people meter 108 prompts the audience members to self-identify (e.g., by selecting identities from a list presented to the audience) (block 314). If the audience member(s) do not self-identify (e.g., by not selecting identities from the list or by indicating that their identities are not contained in the list) (block 316), then the example people meter 108 stores the detected scent as corresponding to an unknown identify (block 320) and the example of FIG. 3 ends. If the audience members self-identify (block 316), or after the example people meter 108 determines that the detected scent matches the recently identified panelist(s) (e.g., panelist 112) (block 308), or after the people in the room confirm their identities (block 312), the example people meter 108 stores the identities (block 318) and the example of FIG. 3 ends.

FIG. 4 is a block diagram of an example implementation of the people meter 108. The example people meter 400 of FIG. 4 includes the electronic nose 110 of FIGS. 1 and/or 2. To reduce redundancy, the electronic nose 110 will be not re-described in connection with FIG. 4. Instead, the interested reader is referred to the discussion of FIGS. 1 and 2 for a full and complete disclosure of the electronic nose 110. To facilitate this process, the electronic nose 110 of FIGS. 1 and 2 is referred to as the electronic nose 110 in FIG. 4. The example people meter 400 of FIG. 4 includes an image processor 401, an audio processor 402, a data transmitter 403, an input 404, a prompter 406, a weight assigner 408, identification logic 410, a database 412, a display 414 and a timestamper 416.

The image processor 401 of the illustrated example detects images of the panelist 112 and/or other audience members in the monitored area 102. An example implementation of the example image processor 401 is discussed in further detail in connection with FIG. 5.

The audio processor 402 of the illustrated example detects audio such as words spoken by the panelist 112 and/or other audience members in the monitored area 102. An example implementation of the example audio processor 402 is discussed in further detail in connection with FIG. 6.

The input 404 of the illustrated example is an interface used by the panelist 112 and/or others to enter information into the people meter 400. In the illustrated example, the input 404 is used to confirm an identity determined by the people meter 400 and/or to enter and/or select an identity of the audience member. In some examples, additional information may be entered via the input 404. Information received via the example input 404 is stored in the local database 412.

The local database 412 of the example people meter 400 may be implemented by any type(s) of memory (e.g., non-volatile random access memory) and/or storage device (e.g., a hard disk drive) capable of retaining data for any period of time. The local database 412 of the illustrated example can store any type of data such as, for example, people identification data.

The prompter 406 of the illustrated example is logic that communicates with the identification logic 410 to control when the people meter 400 prompts a user for additional information (e.g., to confirm an identity) via the display 414.

In the illustrated example, the display 414 is implemented by one or more light emitting diodes (LEDs) mounted to a housing of the people meter 400 for viewing by the audience. However, the display could additionally or alternatively be implemented as a liquid crystal display or any other type of display device. In some examples, the display 414 is omitted and the prompter 406 exports a message to the media device to be overlaid on the media presentation requesting the audience to enter data or take some other action.

The local database 412 of the illustrated example stores panelist identifiers corresponding to panelists. The panelist IDs are stored in association with reference scent fingerprints, reference image fingerprints and reference voice fingerprints (i.e., voiceprints) corresponding to the respective panelist. The example local database 412 also stores identities determined by the people meter 400 and/or identities entered through the input 404 in association with data collected via the image processor 401, the audio processor 402 and/or the electronic nose 110. The local database 412 of FIG. 4 and/or any other database described in this disclosure may be implemented by any memory, storage device and/or storage disc for storing data such as, for example, flash memory, magnetic media, optical media, etc. Furthermore, the data stored in the local database 412 may be in any data format such as, for example, binary data, comma delimited data, tab delimited data, structured query language (SQL) structures, etc. While in the illustrated example the local database 412 is illustrated as a single database, the local database 412 and/or any other database described herein may be implemented by any number and/or type(s) of databases.

The data transmitter 403 of the illustrated example periodically and/or aperiodically transmits data stored in the local database 412 to the central facility 116 via the network 114.

The weight assigner 408 of the illustrated example assigns weights to the identities and/or likelihoods of identities determined by the image processor 401, the audio processor 402 and the electronic nose 110. Weights are assigned to the identity determinations because each of the image processor 401, the audio processor 402 and the electronic nose 110 have different levels of accuracy in identifying panelists. By combining identity determinations of each of the image processor 401, the audio processor 402 and the electronic nose 110, the accuracy of the people meter 400 is increased. In the illustrated example, the weights assigned to each of the image processor 401, the audio processor 402 and the electronic nose 110 are based on the expected accuracy of each in identifying panelists.

The identification logic 410 of the illustrated example is logic that is used to automatically identify panelist(s) based on the data collected by the electronic nose 110, the image processor 401, and/or the audio processor 402 and to control the operation of the example people meter 400. For example, the example identification logic 410 may at least identify the panelist 112 by combining the weighted outputs of the electronic nose 110, the image processor 401, and/or the audio processor 402 and comparing this combination to a threshold as explained below.

The timestamper 416 of the illustrated example is a clock that associates a current time with data. In the illustrated example, the timestamper 416 is a receiver that receives the current time from a cellular phone system. In some other examples, the timestamper 416 is a clock that keeps track of the time. Alternatively, any device that can receive and/or detect the current time may be used as the example timestamper 416. The timestamper 416 of the illustrated example records a time at which a scent is collected by the electronic nose 110, a time at which the image processor 401 collects an image, and/or a time at which the audio processor 402 collects an audio sample (e.g., a voiceprint) in association with the respective data.

While an example manner of implementing the example people meter 400 is illustrated in FIG. 4, one or more of the elements, processes and/or devices illustrated in FIG. 4 may be combined, divided, re-arranged, omitted, eliminated and/or implemented in any other way. Further, the example electronic nose 110, the example image processor 401, the example audio processor 402, the example data transmitter 403, the example input 404, the example prompter 406, the example weight assigner 408, the example identification logic 410, the example database 412, the example display 414, the example timestamper 416, and/or, more generally, the example people meter 400 of FIG. 4 may be implemented by hardware, software, firmware and/or any combination of hardware, software and/or firmware. Thus, for example, any of the example electronic nose 110, the example image processor 401, the example audio processor 402, the example data transmitter 403, the example input 404, the example prompter 406, the example weight assigner 408, the example identification logic 410, the example database 412, the example display 414, the example timestamper 416, and/or, more generally, the example people meter 400 of FIG. 4 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example electronic nose 110, the example image processor 401, the example audio processor 402, the example data transmitter 403, the example input 404, the example prompter 406, the example weight assigner 408, the example identification logic 410, the example database 412, the example display 414, the example timestamper 416, and/or, more generally, the example people meter 400 of FIG. 4 are hereby expressly defined to include a tangible computer readable storage device or storage disc such as a memory, DVD, CD, Blu-ray, etc. storing the software and/or firmware. Further still, the example people meter 400 of FIG. 4 may include one or more elements, processes and/or devices in addition to, or instead of, those illustrated in FIG. 4, and/or may include more than one of any or all of the illustrated elements, processes and devices.

FIG. 5 is a block diagram of an example implementation of the image processor 401 of FIG. 4. The example image processor 401 includes an image sensor 500, an image comparer 502 and an image reference database 504.

The image sensor 500 of the illustrated example detects an image of the area 102 and/or one or more persons (e.g., panelist 112) within the area 102. The image sensor 500 may be implemented with a camera or other image sensing device. The example image sensor 500 communicates with the example local database 412 to store detected images. The example image sensor 500 may collect an image at any desired rate (e.g., continually, once per minute, five times per minute, every second, etc.).

The image comparer 502 of the illustrated example compares an image (or a portion of an image) detected by the image sensor 500 to one or more known reference images (e.g., previously taken images of the panelist 112). In the illustrated example, the image comparer 502 determines the likelihood that the detected image matches a reference image. The image comparison can be performed using any type of image analysis. For example, the image can be converted into a matrix representing pixel values and/or into a signature. The matrix and/or signature may be compared against reference matrices and/or reference signatures from the image reference database 504. The degree to which the constraints match can be converted into a confluence value or likelihood that the image of the person in the room corresponds to a panelist.

In the illustrated example, the image comparer 502 determines absolute values of differences between the image fingerprint under evaluation and the reference image fingerprints. The closer the value of their difference is to zero, the more likely that a match has occurred. The result of the comparison performed by the example image comparer 502 is then converted to a likelihood of a match using any desired conversion function. The operation of the image comparer 502 may be represented by the following equation:

L_{I}_{_{N}}_{=|IF-RIF}_{_{N}}_{|*F}

Where L_{IN} is the likelihood of a match between (1) the image fingerprint (IF) under consideration and (2) reference image fingerprint N (RIF_{N}), and F is a mathematical function for converting the fingerprint difference to a probability. The above calculation is performed N times (i.e., once for every reference image fingerprint in the image reference database 504. In some examples, after the likelihoods are determined, the image comparer 502 selects the highest likelihood(s) (LI_{N}) as the closest match. The person(s) corresponding to the highest likelihood(s) are, thus, identified as present in the audience.

In the example of FIG. 5, image likelihoods (LI_{N}) are but one of several likelihoods considered in identifying the audience member(s). Therein, all of the likelihoods (LI_{N}) are stored in association with the panelist identifier of the corresponding panelist and in association with the record ID of the captured image (e.g., a time at which the scent was captured) to enable usage of the likelihood in one or more further calculations. An example of such an approach is discussed in detail below.

In the illustrated example, the image comparer 502 compares detected images to reference images stored in the image reference database 504. Alternatively, the example image comparer 502 may compare detected images to reference images stored in the local database 412. In some examples, the image reference database 504 is the local database 412.

The image reference database 504 of the illustrated example contains reference images of the panelist 112 and/or other persons associated with the household 102. In the illustrated example, reference images from the panelist 112 and/or other individuals to be monitored by the audience measurement system 100 are detected by the image sensor 500 or another image detection device and stored as reference images in the image reference database 504 and/or the local database 412 during a training process and/or are learned over time by storing reference images in connection with identifications received after prompts.

While an example manner of implementing the example image processor 401 of FIG. 4 is illustrated in FIG. 5, one or more of the elements, processes and/or devices illustrated in FIG. 5 may be combined, divided, re-arranged, omitted, eliminated and/or implemented in any other way. Further, the example image sensor 500, the example image comparer 502, the example image reference database 504, and/or, more generally, the example image processor 401 of FIG. 5 may be implemented by hardware, software, firmware and/or any combination of hardware, software and/or firmware. Thus, for example, any of the example image sensor 500, the example image comparer 502, the example image reference database 504, and/or, more generally, the example image processor 401 of FIG. 5 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example image sensor 500, the example image comparer 502, the example image reference database 504, and/or, more generally, the example image processor 401 of FIG. 5 are hereby expressly defined to include a tangible computer readable storage device or storage disc such as a memory, DVD, CD, Blu-ray, etc. storing the software and/or firmware. Further still, the example image processor 401 of FIG. 5 may include one or more elements, processes and/or devices in addition to, or instead of, those illustrated in FIG. 5, and/or may include more than one of any or all of the illustrated elements, processes and devices.

FIG. 6 is a block diagram of an example implementation of the audio processor 402 of FIG. 4. The example audio processor 402 of FIG. 6 includes an audio sensor 600, an audio comparer 602 and an audio reference database 604.

The audio sensor 600 of the illustrated example detects audio from one or more panelists 112 (e.g., the sound of the panelist 112 speaking, such as a voiceprint). The audio sensor 600 may be implemented with a microphone and an audio receiver or other audio sensing devices. The example audio sensor 600 communicates with the example local database 412 to store detected audio.

The audio comparer 602 of the illustrated example compares audio detected by the audio sensor 600 to one or more known reference audio signals (e.g., a voiceprint or other audio signature based on a previous recording of the panelist 112 speaking). In the illustrated example, the audio comparer 602 determines the likelihood that the detected audio matches a reference signal. In the illustrated example, the audio comparer 602 compares detected audio to reference audio signals stored in the audio reference database 604. Alternatively, the example audio comparer 602 may compare detected audio to reference audio signals stored in the local database 412.

Any method of comparing audio signals may be used by the audio comparer 602. In some examples, to determine if the audio signal matched a reference audio signal, the audio signal is transformed (e.g., via a Fourier transform) into the frequency domain to thereby generate a signal representative of the frequency spectrum of the audio signal. The frequency spectrum of the audio signal comprises a plurality of frequency components, each having a corresponding amplitude. To determine a likelihood that the audio signal matches a reference audio signal, the audio comparer 602 calculates a summation of the absolute values of the differences between amplitudes of corresponding frequency components of the frequency spectrum of the audio signal and the frequency spectrum of a reference audio signal. The closer the summation is to zero, the higher the likelihood the audio signal matches the reference audio signal. An example equation to compare a summation of the absolute values of the differences between amplitudes of corresponding frequency components of the frequency spectrum of the audio signal captured by the audio processor and the frequency spectrum of a reference audio signal is illustrated below. In the illustrated equation, f_{N}_{_{A}} represents a frequency component of the frequency spectrum of the audio signal under consideration, f_{N}_{_{E}} is the corresponding frequency component of the frequency spectrum of the reference audio signal being compared, and X_{N} is the summation value corresponding to a reference voiceprint (N):

$${{\sum }_{0}}^{N} \vert {f}_{{N}_{A}} - {f}_{{N}_{E}} \vert = {X}_{N}$$

Each value of X_{N} can be fitted to a likelihood curve to determine the confidence (e.g. likelihood) that a match has occurred. As mentioned, the closer X_{N} is to zero, the higher the likelihood of a match. Other techniques for comparing the audio signal to the reference signals may alternatively be additionally or alternatively be employed. An example equation for converting the summation values (i.e., the sum of the differences between the frequency components of the audio signal and a given reference voiceprint) to a likelihood of a match (L_{AN}) is shown in the following equation:

L_{AN}=X_{N}*F

where F is a mathematical function for converting the summation value X_{N} to a probability.

The audio reference database 604 of the illustrated example contains reference audio signals (e.g., reference voiceprints) that correspond to the panelist 112 or other persons who may be present in the household 102. In the illustrated example, reference audio signals from the panelist 112 and/or other individuals to be monitored by the audience measurement system 100 are detected by the audio sensor 600 or another audio detection device and stored as reference audio signals in the audio reference database 604 and/or the local database 412 during, for example, a tuning exercise and/or are learned over time by storing voiceprints in connection with identifications received after prompts.

While an example manner of implementing the example audio processor 402 of FIG. 4 is illustrated in FIG. 6, one or more of the elements, processes and/or devices illustrated in FIG. 6 may be combined, divided, re-arranged, omitted, eliminated and/or implemented in any other way. Further, the example audio sensor 600, the example audio comparer 602, the example audio reference database 604, and/or, more generally, the example audio processor 402 of FIG. 6 may be implemented by hardware, software, firmware and/or any combination of hardware, software and/or firmware. Thus, for example, any of the example audio sensor 600, the example audio comparer 602, the example audio reference database 604, and/or, more generally, the example audio processor 402 of FIG. 6 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example audio sensor 600, the example audio comparer 602, the example audio reference database 604, and/or, more generally, the example audio processor 402 of FIG. 6 are hereby expressly defined to include a tangible computer readable storage device or storage disc such as a memory, DVD, CD, Blu-ray, etc. storing the software and/or firmware. Further still, the example audio processor 402 of FIG. 6 may include one or more elements, processes and/or devices in addition to, or instead of, those illustrated in FIG. 6, and/or may include more than one of any or all of the illustrated elements, processes and devices.

FIG. 7 is a block diagram of an example implementation of the media meter 106 of FIG. 1. The media meter 106 of the illustrated example is used to collect, aggregate, locally process, and/or transfer data to the central data facility 116 via the network 114 of FIG. 1. In the illustrated example, the media meter 106 is used to extract and/or analyze codes and/or signatures from data and/or signals emitted by the media device 104 (e.g., free field audio detected by the media meter 106 with a microphone exposed to ambient sound). The example media meter 106 also communicates with and/or receives data from the example people meter 108. The example media meter 106 contains an input 702, a code collector 704, a signature collector 706, control logic 708, a database 710 and a transmitter 712.

Identification codes, such as watermarks, codes, etc. may be embedded within media signals. Identification codes are digital data that are inserted into content (e.g., audio) to uniquely identify broadcasters and/or media (e.g., content or advertisements), and/or are carried with the media for another purpose such as tuning (e.g., packet identifier headers (“PIDs”) used for digital broadcasting). Codes are typically extracted using a decoding operation.

Media signatures are a representation of some characteristic of the media signal (e.g., a characteristic of the frequency spectrum of the signal). Signatures can be thought of as fingerprints. They are typically not dependent upon insertion of identification codes in the media, but instead preferably reflect an inherent characteristic of the media and/or the media signal.

Systems to utilize codes and/or signatures for audience measurement are long known. See, for example, Thomas, U.S. Pat. No. 5,481,294, which is hereby incorporated by reference in its entirety.

In the illustrated example, the input 702 obtains a data signal from a device, such as the media device 104. In some examples, the input 702 is a microphone exposed to ambient sound in a monitored location (e.g., area 102) and serves to collect audio played by an information presenting device. The input 702 of the illustrated example passes the received signal (e.g., a digital audio signal) to the code collector 704 and/or the signature generator 706. The code collector 704 of the illustrated example extracts codes and/or the signature generator 706 generates signatures from the signal to identify broadcasters, channels, stations, broadcast times, advertisements, content, and/or programs. The control logic 708 of the illustrated example is used to control the code collector 704 and the signature generator 706 to cause collection of a code, a signature, or both a code and a signature. The identified codes and/or signatures are stored in the database 710 of the illustrated example and are transmitted to the central facility 116 via the network 114 by the transmitter 712 of the illustrated example. Although the example of FIG. 7 collects codes and/or signatures from an audio signal, codes or signatures can additionally or alternatively be collected from other portion(s) of the signal (e.g., from the video portion).

While an example manner of implementing the media meter 106 of FIG. 1 is illustrated in FIG. 7, one or more of the elements, processes and/or devices illustrated in FIG. 7 may be combined, divided, re-arranged, omitted, eliminated and/or implemented in any other way. Further, the example input 702, the example code collector 704, the example signature collector 706, the example control logic 708, the example database 710, the example transmitter 712, and/or, more generally, the example media meter 106 of FIG. 7 may be implemented by hardware, software, firmware and/or any combination of hardware, software and/or firmware. Thus, for example, any of the example input 702, the example code collector 704, the example signature collector 706, the example control logic 708, the example database 710, the example transmitter 712, and/or, more generally, the example media meter 106 of FIG. 7 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example, input 702, the example code collector 804, the example signature collector 706, the example control logic 708, the example database 710, the example transmitter 712, and/or, more generally, the example media meter 106 of FIG. 7 are hereby expressly defined to include a tangible computer readable storage device or storage disc such as a memory, DVD, CD, Blu-ray, etc. storing the software and/or firmware. Further still, the example media meter 106 of FIG. 1 may include one or more elements, processes and/or devices in addition to, or instead of, those illustrated in FIG. 7, and/or may include more than one of any or all of the illustrated elements, processes and devices.

Flowcharts representative of example machine readable instructions for implementing the example people meter 400 of FIG. 4 and the example media meter 106 of FIGS. 1 and/or 7 are shown in FIGS. 8-11. In this example, the machine readable instructions comprise a program for execution by a processor such as the processor 1612 shown in the example processor platform 1600 discussed below in connection with FIG. 16. The programs may be embodied in software stored on a tangible computer readable storage medium such as a CD-ROM, a floppy disk, a hard drive, a digital versatile disk (DVD), a Blu-ray disk, or a memory associated with the processor 1612, but the entire program and/or parts thereof could alternatively be executed by a device other than the processor 1612 and/or embodied in firmware or dedicated hardware. Further, although the example program is described with reference to the flowcharts illustrated in FIGS. 8-11, many other methods of implementing the example people meter 400 of FIG. 4 and the example media meter 106 of FIGS. 1 and/or 7 may alternatively be used. For example, the order of execution of the blocks may be changed, and/or some of the blocks described may be changed, eliminated, or combined.

As mentioned above, the example processes of FIGS. 8-11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 8-11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 8 is a flowchart representative of example machine readable instructions for implementing the example people meter 400 of FIG. 4. FIG. 8 begins when the example people meter 400 determines whether it has been triggered to collect data (block 802). The example people meter 400 may be triggered to collect data in any number of ways and/or in response to any type(s) of event(s). For example, the people meter 400 may collect data at regular intervals defined by a timer (e.g., once every second, once every three seconds, once every minute, etc.). If the example people meter 400 determines that it is not triggered to collect data (block 802), control waits at block 802 until such a trigger occurs.

If the example people meter 400 of the illustrated example determines that it is time to collect data (block 802), the example electronic nose 110 detects a scent (block 804). The example image processor 401 captures an image (block 806). The example audio processor 402 captures audio (block 808). The example timestamper 416 determines the time and timestamps the collected data (block 810). The example database then stores the detected scent, the captured image, the captured audio with their respective timestamps (block 812). The example people meter 400 then determines whether it is to power down (block 814). If the example people meter 400 determines that it is not to power down (block 814), control returns to block 802. If the example people meter 400 determines that it is to power down (block 814), then the example process of FIG. 8 ends.

FIGS. 9A and 9B together are a flowchart representative of example machine readable instructions for implementing the example people meter 400 of FIG. 4 when analyzing data. FIG. 9 begins when the example scent comparer 202 comparers scent fingerprints corresponding to scent(s) detected at a corresponding time to one or more reference scents in the example scent reference database 204 and/or the example local database 412 (block 902). The example scent comparer 202 then determines the probabilities that the detected scent matches one or more reference scents (e.g., as discussed below in connection with FIG. 12) (block 904).

The example image comparer 502 compares an image detected at the corresponding time at which the scent was collected to one or more reference images in the example image reference database 504 and/or the example local database 412 (block 906). The example image comparer 502 then determines the probabilities that the detected image matches one or more reference images (e.g., as discussed below in connection with FIG. 13) (block 908). The example image comparer 502 determines the number of people in the room by analyzing the detected image (block 910). Such a count can be generated in accordance with the teachings of U.S. Pat. No. 7,609,853 and/or U.S. Pat. No. 7,203,338.

The example audio comparer 602 compares audio detected at the corresponding time to one or more reference audio signals in the example audio reference database 604 and/or the example local database 412 (block 1912). The example audio comparer 602 then determines the probabilities that the detected audio matches one or more reference audio signals (e.g., as shown in FIG. 14) (block 914).

The example weight assigner 408 then assigns a weight to each of the determined probabilities (block 916). In the illustrated example, probabilities determined by the example image processor 401 are weighted by a first weight, probabilities determined by the example audio processor 402 are weighted by a second weight and probabilities determined by the example electronic nose 110 are weighted by a third weight. The example identification logic 410 then computes a weighted sum of the determined probabilities for each panelist identifier corresponding to a detected scent, a detected image, and/or detected audio (block 918). The example identification logic 410 determines a weighted probability average for each candidate panelist identifier by dividing each of the weighted sums by the number of probabilities (e.g., in this example three, namely, the scent probability, the image probability and the audio probability) (block 920). An example weighted probability average calculation is discussed in connection with FIG. 15. The example process of FIG. 9 then continues with block 922 of FIG. 9B.

The example identification logic 410 then determines whether the highest weighted probability averages corresponding to the determined number of people in the room are above a threshold (e.g., if there are two people in the room, the identification logic 410 compares the two highest weighted probability averages to a threshold, or alternatively, compares the lowest of the two highest probabilities to the threshold)) (block 922). In the illustrated example, the threshold corresponds to the lowest acceptable level of confidence in the accuracy (e.g., 50%, 70%, 80%, etc.). If the example identification logic 410 determines that the highest weighted probability averages corresponding to the number of people in the room are not all above the threshold (block 922), then control passes to block 930.

If the example identification logic 410 determines that the highest weighted probability averages corresponding to the number of people in the room are all above the threshold (block 922), then the identification logic 410 determines if the panelist identifiers corresponding to the highest weighted probability averages identify the same panelists identified in the first identification iteration of FIGS. 9A and 9B (block 924). If the identified panelists are the same as panelists identified in the last iteration (block 924), control passes to block 934. If the identified panelists are not the same as the previously identified panelists (block 924), then the example prompter 406 prompts the panelists, via the example display 414, to confirm that the determined identities are correct (block 928).

If the panelists confirm that the determined identities are correct (block 928), then control passes to block 934. If the panelists do not confirm that the determined identities are correct (block 928), the example prompter 406 prompts the panelists, via the example display 414, to identify themselves using the example input 404 (block 930). The example prompter 406 then determines whether the panelists have identified themselves (block 932). If the panelists have not identified themselves (block 932), then control passes to block 936.

If the panelists have identified themselves (block 932), or after the panelists confirm that their identities match the determined identities (block 928), or after the identification logic 410 determines that the identified panelists are the same as previously identified panelists (block 924), the identification logic 410 stores the identities of the panelists in the example local database 412 for the corresponding time (i.e., the time at which the scent, image and audio under examination were collected) and control passes to block 938.

After the example identification logic 410 determines that the panelists have not identified themselves (block 932), the identification logic 410 stores unknown identities for the panelists in the example local database 412 at the corresponding time and the identification logic stores the detected images, audio and scents in the local database 412 (block 936). After storing the detected images, audio and scents and unknown identities in the example local database 412 (block 936) or after storing the identities of the panelists in the local database 412 (block 932), the example data transmitter 403 determines whether to transmit data (e.g., based on the amount of time since the last data transmission, based on the amount of data stored in the local database 412, etc.) (block 938).

If the example data transmitter 403 determines it is appropriate to transmit data (block 938), then the data transmitter transmits the data in the example local database 412 to the central facility 116 via the network 114 (block 940). If the example data transmitter 403 determines it is not yet time to transmit data (block 938), then control passes to block 942.

After the example data transmitter 403 transmits data (block 940) or after the data transmitter 403 determines not to transmit data until a later time (block 938), the example people meter 400 determines whether to power down (e.g., based on whether the media device 104 has powered down) (block 942). If the example people meter 400 determines that it is not to power down, then control returns to block 902 of FIG. 9A. If the example people meter 400 determines that it is to power down, the example of FIG. 9 ends.

FIG. 10 is a flowchart representative of example machine readable instructions for implementing the example media meter 106 of FIGS. 1 and 7. The example of FIG. 10 begins when the example media meter 106 determines if the example input 702 has detected a code (e.g., an audio code emitted by the example media device 104) (block 1002). If the example input 702 has detected a code (block 1002), control passes to block 1006. If the example media meter 106 has not detected a code (block 1002), the example signature collector 706 collects and/or generates a signature based on the media received by the example input 702 (block 1004).

After the example signature collector 706 collects and/or generates a signature (block 1004) or after the example input 702 determines that the input has detected a code (block 1002), the example media meter 106 determines a current time and timestamps the detected code or collected signature (block 1006). The example database 710 then stores the timestamped code or the timestamped signature (block 1008).

The example control logic 708 determines whether the example media meter 106 is to transmit data (e.g., based on the time since data was last transmitted, based on the amount of data stored in the example database 710, etc.) (block 1010). If the example control logic 708 determines that the example media meter 106 is not to transmit data (block 1010), control returns to block 1002. If the example control logic 708 determines that the example media meter 106 is to transmit data (block 1010), the example control logic 708 determines whether the media meter 106 is to power down (e.g., based on whether the example media device 104 is powered down) (block 1014). If the example control logic determines that the example media meter 106 is not to power down (block 1014), control returns to block 1002. If the example control logic determines that the example media meter 106 is to power down (block 1014), the example of FIG. 10 ends.

FIG. 11 is a flowchart representative of example machine readable instructions for implementing the example people meter 400 of FIG. 4. The example of FIG. 11 illustrates a modification of the processes of FIGS. 9A and 9B to identify the members of the audience only when the members of the audience have changed. This reduces the number of times that the audience members must be identified by the measurement system 100 (e.g., to reduce fatiguing/irritating the audience with excessive prompting). The example of FIG. 11 begins with the example image sensor 500 collecting an image of the audience (block 1102). The example image comparer 502 then counts the number of people in the audience (e.g., by determining the number of distinct figures (e.g., blobs) in the detected image (e.g., by building a histogram of centers of motion over a series of images)) (block 1104). The example identification logic 410 then determines whether the number of people in the audience counted by the image comparer 502 has changed since the last time the image comparer 502 counted the number of people in the audience (block 1106). The processes of FIG. 11 may iterate between blocks 1102 and 1104 in order to count the people in the audience.

If the example identification logic 410 determines that the number of people in the audience has changed (block 1106), control passes to block 1110. If the example identification logic 410 determines that the number of people in the audience has not changed (block 1106), then the example identification logic 410 determines whether a timer has expired (e.g., a certain time has elapsed since the last audience identification was made) (block 1108). The use of a timer causes the measurement system 100 to periodically update the identification of audience members even if the number of people in the audience has not changed (e.g., to detect circumstances where one audience member has left the room and another has joined the room, thereby changing the audience members without changing the number of audience members). If the timer has not expired (block 1108), control returns to block 1102).

If the timer has expired (block 1108), then the example people meter 400 collects data by using the example process discussed in connection with FIG. 8 (block 1110). The example people meter 400 then begins the audience identification process discussed in connection with FIGS. 9A-9B (block 1112). The example people meter 400 then determines whether to power down (e.g., based on whether the example media device 104 has powered down) (block 1114). If the example people meter 400 determines not to power down (block 1114), control returns to block 1102. If the example people meter 400 determines to power down (block 1114), then the example of FIG. 11 ends.

FIG. 12 illustrates an example scent record table 1200 that may be generated by the example electronic nose 110. In the example of FIG. 12, row 1202 of table 1200 indicates that the electronic nose 110 determined the probability that a detected scent collected at 3:10:05 matched a panelist with panelist ID 1 was 80%, the probability that the detected scent matched a panelist with panelist ID 2 was 10% and the probability that the detected scent matched a panelist with panelist ID 3 was 5%. Row 1204 of table 1200 indicates that the example electronic nose 110 determined the probability that a detected scent collected at 3:11:10 matched a panelist with panelist ID 1 was 60%, the probability that the detected scent matched a panelist with panelist ID 2 was 30% and the probability that the detected scent matched a panelist with panelist ID 3 was 5%.

FIG. 13 illustrates an example image record table 1300 that may be generated by the example image processor logic 401. In the example of FIG. 13, row 1302 of table 1300 indicates that the example image processor 401 determined the probability that a captured image recorded at time 3:10:05 matched a panelist with panelist ID 1 was 60%, the probability that the captured image matched a panelist with panelist ID 2 was 30% and the probability that the captured image matched a panelist with panelist ID 3 was 5%. Row 1304 of table 1300 indicates the example image processor 401 determined the probability that a captured image recorded at 3:11:10 matched a panelist with panelist ID 1 was 65%, the probability that the captured image matched a panelist with panelist ID 2 was 25% and the probability that the captured image matched a panelist with panelist ID 3 was 5%.

FIG. 14 illustrates an example audio record table 1400 that may be generated by the example audio processor 402. In the example of FIG. 14, row 1402 of table 1400 indicates that the example audio sensor 402 determined the probability that captured audio recorded at time 3:10:05 matched a panelist with panelist ID 1 was 40%, the probability that the captured audio matched a panelist with panelist ID 2 was 20% and the probability that the captured audio matched a panelist with panelist ID 3 was 25%. Row 1404 of table 1400 indicates that the example audio sensor 402 determined the probability that detected audio recorded at time 3:11:10 matched a panelist with panelist ID 1 was 35%, the probability that the detected audio matched a panelist with panelist ID 2 was 15% and the probability that the detected audio matched a panelist with panelist ID 3 was 35%.

FIG. 15 is an example table 1500 illustrating example calculations of weighted averages of the probabilities that panelist 1, panelist 2 and panelist 3 are the individuals present at time 3:10:05 using example data from tables 1200, 1300 and 1400 from FIGS. 12-14. In the example of FIG. 15, row 1502 indicates the weighted average computation for the panelist identifier corresponding to panelist ID 1, row 1504 indicates the weighted average computation for the panelist identifier corresponding to panelist ID 2 and row 1506 indicates the weighted average computation for the panelist identifier corresponding to panelist ID 3. In the example of FIG. 15, column 1508 indicates that the weight used for the example electronic nose 110 is 1, column 1514 indicates that the weight used for the example image processor 401 is 1.3, and column 1520 indicates that the weight used for the example audio processor 402 is 0.8.

Column 1510 of table 1500 indicates that the example identification logic 410 determined that the likelihoods that a detected scent matched panelists 1, 2 and 3 are 80%, 10% and 5% respectively, as shown in FIG. 12. In column 1512, the scent weighted likelihoods are calculated by multiplying these probabilities by the scent weight of 1.

Column 1516 of table 1500 indicates that the example identification logic 410 determined that the likelihoods that a captured image matched panelists 1, 2 and 3 is 60%, 30% and 5% respectively, as shown in FIG. 13. In column 1518, the image weighted likelihoods are calculated by multiplying these probabilities by the image weight of 1.3.

Column 1522 of table 1500 indicates that the example identification logic 410 determined that the likelihoods that a captured image matched panelists 1, 2 and 3 are 40%, 20% and 25% respectively, as shown in FIG. 15. In column 1524, the image weighted likelihoods are calculated by multiplying these probabilities by the audio weight of 0.8.

Column 1526 of table 1500 indicates the total weighted averages of the weighted likelihoods of columns 1512, 1518 and 1524. The total weighted averages of column 1526 are calculated by summing the weighted likelihoods in column 1512, 1518 and 1524 and dividing by the number of likelihoods (e.g., three, the count of likelihoods L_{S}, L_{I}, and L_{A}) of the weights in columns 1508, 1514 and 1520. Thus, the computation of the weighted average follows the following formula:

$${A}_{x} = \frac{( {W}_{s} ) ( {L}_{sx} ) + ( {W}_{i} ) ( {L}_{ix} ) + ( {W}_{a} ) ( {L}_{ax} )}{3}$$

In the above equation, x is an index to identify the corresponding panelist (e.g., x=1 for panelist 1, x=2 for panelist 2, etc.). Wₛ is the weight applied to the scent probability, Wᵢ is the weight applied to the image probability and Wₐ is the weight applied to the audio probability. Lₛ is the scent probability, Lᵢ is the image probability and Lₐ is the audio probability.

Applying the above formula, in row 1502, the weighted average that panelist 1 is in the monitored audience is (80%+78%+40%)/(3)=66%. In row 1504, the weighted average that panelist 2 is in the monitored audience is (10%+39%+16%)/(3)=22%. In row 1502, the weighted average that panelist 3 is in the monitored audience is (5%+7%+20%)/(3)=11%.

FIG. 16 is a block diagram of an example processor platform 1700 capable of executing the instructions of FIGS. 3, 8-10 and/or 11 to implement the example people meter 108 of FIG. 1, the example people meter 400 of FIG. 4 and/or the example media meter 106 of FIGS. 1 and 7. The processor platform 1600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit a user to enter data and commands into the processor 1612. The input device(s) can be implemented by, for example, an audio processor, a microphone, a camera (still or video), a keyboard, a button, a mouse, a touchscreen, a track-pad, a trackball, isopoint and/or a voice recognition system.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1620 of the illustrated example, thus, typically includes a graphics driver card.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.).

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID systems, and digital versatile disk (DVD) drives.

The coded instructions 1632 of FIGS. 3, 8-10 and/or 11 may be stored in the mass storage device 1628, in the volatile memory 1614, in the non-volatile memory 1616, and/or on a removable tangible computer readable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

1. An apparatus comprising:
a media meter to collect media identification information to identify media presented by an information presentation device;
a people meter to identify a person in an audience of the information presentation device the people meter comprising:
a scent detector to detect a first scent of the person;
a scent database containing a set of reference scents;
a scent comparer to determine a first likelihood that the person corresponds to a first panelist identifier by comparing the first scent to at least some of the reference scents in the set; and
identification logic to identify the person as corresponding to the first panelist identifier based on the first likelihood.

2. An apparatus as defined in claim 1, wherein the first panelist identifier and a second panelist identifier are respectively associated with first and second reference scents in the scent database.

3. An apparatus as defined in claim 2, wherein the first and second panelist identifiers respectively identify unique panelists.

4. An apparatus as defined in claim 1, wherein the people meter comprises a prompter to prompt the person to self-identify if the first scent does not correspond to one of the reference scents in the set.

5. An apparatus as defined in claim 1, wherein the people meter further comprises a prompter to prompt the person to confirm they are identified by the first panelist identifier.

6. An apparatus as defined in claim 2, wherein the people meter further comprises:
an image processor to capture an image of the person, the image processor to determine a second likelihood that the person corresponds to the first panelist identifier by comparing the image to at least some reference images in a set of reference images; and
an audio processor to capture audio associated with the person, the audio processor to determine a third likelihood that the person corresponds to the first panelist identifier by comparing the audio with at least some reference audio segments in a set of reference audio segments.

7. An apparatus as defined in claim 6, further comprising a weight assigner to:
apply a first weight to the first likelihood;
apply a second weight to the second likelihood;
apply a third weight to the third likelihood.

8. An apparatus as defined in claim 7, wherein the people meter further comprises a prompter to prompt the person to confirm they are identified by the first panelist identifier.

9. An apparatus as defined in claim 7, wherein the identification logic is to identify the person based on an average of the first, second and third likelihoods.

10. An apparatus as defined in claim 9, wherein the identification logic computes the average by (A) computing a first sum of (1) a product of the first weight and the first likelihood, (2) a product of the second weight and the second likelihood, and (3) a product of the third weight and the third likelihood; and (B) dividing the first sum by a count of the likelihoods.

11. An apparatus as defined in claim 9, wherein the identification logic is to determine a first probability that the person corresponds to the first panelist identifier based on the average.

12. An apparatus as defined in claim 11, wherein the identification logic is to identify the person as corresponding to a first panelist identifier if the first probability is greater than a threshold probability.

13. An apparatus as defined in claim 11, wherein the people meter comprises a prompter to prompt the audience member to self-identify if the first probability is less than a threshold probability.

14. An apparatus as defined in claim 7, wherein the image processor is to determine a total number of persons in the audience, the scent detector to detect scents of each person in the audience and determine a likelihood that each person corresponds to a panelist identifier, the image processor to capture an image of each person in the audience and determine a likelihood that each person corresponds to a panelist identifier, the audio processor to capture audio associated with each person in the audience and determine a likelihood that each person corresponds to a panelist identifier, the identifier logic to identify each person in the audience based on the determined likelihoods.

15. A method comprising:
collecting media identification information to identify media presented by an information presentation device;
detecting a first scent of a person in an audience;
determining a first likelihood that the person corresponds to a first panelist identifier by comparing the first scent to at least some reference scents in a set of reference scents; and
identifying the person as corresponding to the first panelist identifier based on the first likelihood.

16. A method as defined in claim 15, wherein the first panelist identifier and a second panelist identifier are respectively associated with first and second reference scents in the set of reference scents.

17. A method as defined in claim 16, wherein the first and second panelist identifiers respectively identify unique panelists.

18. A method as defined in claim 15, further comprising prompting the person to self-identify if the first scent does not correspond to one of the reference scents in the set.

19. A method as defined in claim 15, further comprising prompting the person to confirm they are identified by the first panelist identifier.

20. A method as defined in claim 16, wherein further comprising:
capturing an image of the person;
determining a second likelihood that the person corresponds to the first panelist identifier by comparing the image to at least some reference images in a set of reference images;
capturing audio associated with the person.

21. A method as defined in claim 20, further comprising:
applying a first weight to the first likelihood;
applying a second weight to the second likelihood;
applying a third weight to the third likelihood; and
identifying the person based on a the first weight, the second weight and the third weight.

22. A method as defined in claim 21, further comprising prompting the person to confirm they are identified by the first panelist identifier.

23. A method as defined in claim 21, wherein identifying the person based on the first likelihood comprises identifying the person based on an average of the first, second and third likelihoods.

24. A method as defined in claim 23, further comprising computing the average by (A) computing a first sum of (1) a product of the first weight and the first likelihood, (2) a product of the second weight and the second likelihood, and (3) a product of the third weight and the third likelihood; and (B) dividing the first sum by a count of the likelihoods.

25. A method as defined in claim 24, wherein identifying the person further comprises determining a first probability that the person corresponds to the first panelist identifier based on the average.

26. A method as defined in claim 25, wherein identifying the person further comprises identifying the person as corresponding to a first panelist identifier if the first probability is greater than a threshold probability.

27. A method as defined in claim 25, further comprising prompting the person to self-identify if the first probability is less than a threshold probability.

28. A method as defined in claim 21, further comprising:
determining a total number of persons in the audience;
detecting scents of each person in the audience;
determining a likelihood that each person corresponds to a panelist identifier;
capturing an image of each person in the audience;
determining a likelihood that each person corresponds to a panelist identifier;
capturing audio associated each person in the audience;
determining a likelihood that each person corresponds to a panelist identifier; and
identifying each person in the audience based on the determined likelihoods.

29. A tangible machine readable storage medium comprising instructions that, when executed, cause the machine to at least:
collect media identification information to identify media presented by an information presentation device; and
identify a person in an audience of the information presentation device by:
detecting a first scent of the person;
determining a first likelihood that the person corresponds to a first panelist identifier by comparing the first scent to at least some reference scents in a set of reference scents; and
identifying the person as corresponding to a first panelist identifier based on the first likelihood.

30.-42. (canceled)
